(19) United States
(12) Patent Application Publication
(10) Pub. No.: US 2002/0159709 A1
(43) Pub. Date: Oct. 31, 2002

(54) Fiber optic bundle matching connector

(76) Inventor: Robert J. Faus, Longmont, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/844,026

(22) Filed: Apr. 27, 2001

(51) Int. Cl. G02B 6/40

(52) U.S. Cl. 385/54; 385/53; 385/76

(57) ABSTRACT

A fiber optic cable coupler comprises a housing adapted to receive a first fiber optic cable and a cable connector having a distal end and a proximal end. The distal end of the cable connector is adapted to engage the housing and the proximal end of the cable connector is adapted to receive a second fiber optic cable. The first and second fiber optic cables each have an exposed end. The cable connector retains the second fiber optic cable so that the second fiber optic cable exposed end is opposed to and in longitudinal alignment with the first fiber optic cable exposed end. The cable connector is also adapted to maintain a user selectable distance between the first fiber optic cable exposed end and the second fiber optic cable exposed end.

### FIELD OF THE INVENTION

The present invention pertains to bundled fiber optic cables and more particularly to the coupling of bundled fiber optic cables with different diameters.

### BACKGROUND OF THE INVENTION

Optical spectrometers allow the study of a large variety of samples over a wide range of wavelengths. Materials can be studied in the solid, liquid, or gas phase either in a pure form or in mixtures. Various designs allow the study of spectra as a function of temperature, pressure, and external magnetic fields.

Known optical spectrometers utilize one or more fiber-optic strands to deliver light energy to an internal spectrum analyzer. The spectrum analyzer measures the energy of the light energy at different wavelengths, processes it, and outputs the results to a computer. Often, an assembly of many fiber-optic strands (a fiber optic bundle) is used to deliver light energy to the analyzer. Similarly, a fiber optic bundle will deliver light energy to a series of analyzers, with a specified set of strands connected to one particular analyzer. Frequently, spectrophotometer systems utilize an external sampling fiber optic cable, or bundle, to bring the light energy from a desired sample to the spectrophotometer case, while a second internal fiber optic cable or bundle delivers the collected light energy to the analyzer.

When utilizing multiple fiber optic bundles to transfer light energy to a spectral analyzer it is essential that all of the collected light energy be delivered equally and evenly from one bundle to the other. Unequal illumination of the fibers may result in both wavelength and amplitude errors in a measured spectrum. In addition, because each of the individual fibers in the sampling bundle may be transmitting slightly different signals, they should equally contribute to the total signal transmitted to the spectrophotometer's internal fiber optic bundle.

Often, when external sensing cable bundles are connected to the spectrometer, the profile of the fiber optic cable does not match the connector profile on the spectrometer. This can result in many of the previously mentioned problems.

In order to connect the sampling cable to the spectrophotometer internal fiber optic cable, known fiber optic couplers position the two cables in contact with one another. This type of coupler works well with single strand fiber optic cables having equal diameters. But they often fail to achieve a satisfactory connection between cable bundles or between a single strand cable and a cable bundle. For example, when the bundle delivering light to the spectrometer is smaller than the instrument's internal fiber optic bundle, some of the instrument's fibers may not be illuminated, resulting in potential measurement errors. And, when the external bundle is larger, some of the external bundle's fibers may not contribute any, or a sufficient amount of, their collected light energy to the instrument's fiber optic bundle.

Other approaches, such as the use of collimation optics, also do not address the problem that results from coupling fiber optic bundles having dissimilar sizes. Additionally, the use of collimating optics causes throughput losses due to the presence of additional air/glass interfaces and due to the absorbance of the glass itself.

An additional problem arises where an incoming fiber optic bundle is split into two or more individual fiber optic bundles within the spectrometer and the smaller bundles are then routed to separate spectrum analyzers. If the initial fiber optic bundle does not receive an even distribution of light energy from the sampling source, the several spectrum analyzers within the spectrophotometer may receive different levels of light energy. Some of the spectra analyzers may not receive any light energy at all.

Furthermore, known systems for attempting to accommodate the above problems do not provide for an adequate amount of reproducibility in the alignment and positioning of the incoming and internal fiber optic cables bringing into question the accuracy of repeated measurements.

### SUMMARY OF THE INVENTION

In one aspect, a fiber optic cable coupler comprises a housing adapted to receive a first fiber optic cable, the first fiber optic cable having an exposed end. The fiber optic cable coupler also comprises a cable connector having a distal end and a proximal end, the distal end adapted to engage the housing, the proximal end adapted to receive a second fiber optic cable having an exposed end. The cable connector retains the second fiber optic cable so that the second fiber optic cable exposed end is opposed to and in longitudinal alignment with the first fiber optic cable exposed end. The cable connector is also adapted to maintain a user selectable distance between the first fiber optic cable exposed end and the second fiber optic cable exposed end.

In another aspect, a device for transmitting light energy from an exposed end of a first fiber optic cable bundle to an exposed end of a second fiber optic cable bundle comprises a first housing adapted to retain the first fiber optic cable bundle, the first housing having a longitudinal axis and a passage extending along the longitudinal axis. The device also comprises a second housing adapted to engage the first housing and retain the second fiber optic cable bundle, the second housing adapted to maintain a user selected distance between the first and second fiber optic cable bundle exposed ends.

In a further aspect, a method of coupling fiber optic cables having different diameters comprises retaining a first fiber optic cable in a first position, the first fiber optic cable having an exposed end, retaining a second fiber optic cable in a second position, the second fiber optic cable having an exposed end, longitudinally aligning the first and second fiber optic cable exposed ends, and adjusting the distance between the first and second fiber optic cable exposed ends so that light energy emitted by the first fiber optic cable exposed end evenly illuminates the second fiber optic cable exposed end.

As will become apparent to those skilled in the art, numerous other embodiments and aspects of the invention will become evident hereinafter from the following descriptions and claims.

### BRIEF DESCRIPTION OF THE DRAWINGS

The drawings illustrate both the design and utility of the preferred embodiments of the present invention, wherein:

FIG. 1 is a diagram showing a spectrophotometer system utilizing a fiber optic bundle matching connector constructed in accordance with the present invention;

FIG. 2 is a diagram showing selected internal fiber optic components and connections of the spectrophotometer system of FIG. 1;

FIG. 3 is an exploded perspective view of a typical connection between a spectrophotometer housing and an external fiber optic connector;

FIGS. 3A and 3B are cross sectional views of a contact-type alignment of differently sized fiber optic cable bundles;

FIGS. 4A and 4B are cross sectional views of the alignment of differently sized fiber optic cable bundles in accordance with the present invention

FIG. 5 is an exploded perspective view of a fiber optic bundle matching connector constructed in accordance with the present invention;

FIGS. 6A and 6B are side and front cross sectional views of a fiber optic bundle matching connector constructed in accordance with the present invention;

FIGS. 7A and 7B are side and front cross sectional views of a fiber optic bundle matching connector housing constructed in accordance with the present invention;

FIGS. 8A-8C are side, front and rotated side cross sectional views of a fiber optic bundle matching connector jam nut constructed in accordance with the present invention;

FIGS. 9-12 are various views of a fiber optic bundle matching connector cable connector constructed in accordance with the present invention; and

FIGS. 13A and 13B are views of how a fiber optic bundle matching connector constructed in accordance with the present invention varies the distance between a pair of fiber optic cable bundles.

### DETAILED DESCRIPTION

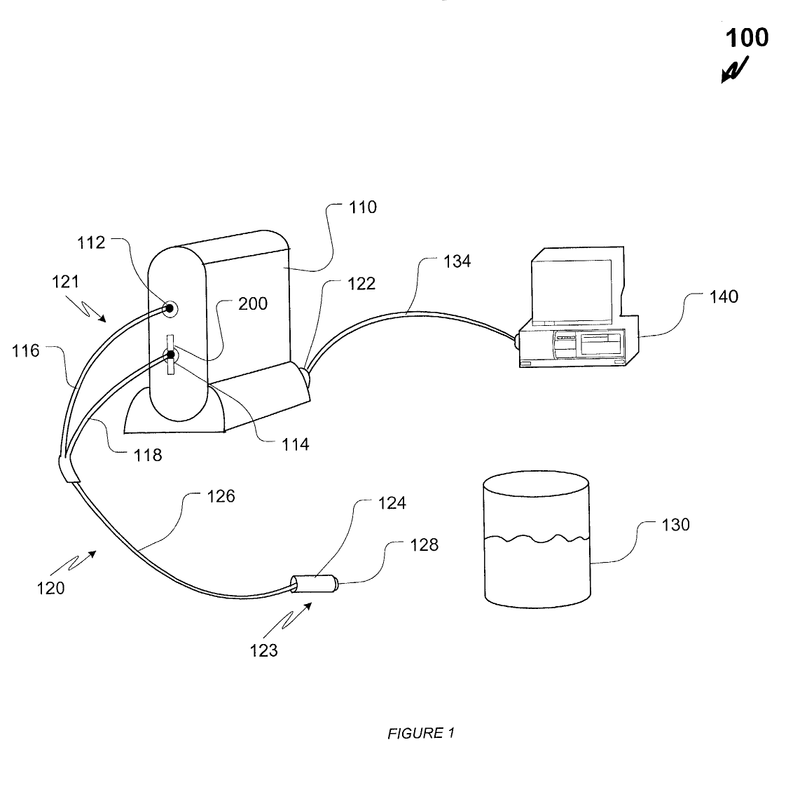

FIG. 1 shows a spectrophotometer system 100. The spectrophotometer system 100 generally includes a spectrophotometer 110 and a general purpose computer 140. Preferably the general purpose computer 140 is a personal computer or other known system capable of organizing and analyzing data gathered by the spectrophotometer 1110. The computer 140 is preferably programmed to analyze spectrophotometric data in accordance with known industry applications.

The spectrophotometer 110 includes a light output terminal 112 that transmits a white light source from inside the spectrophotometer 110, an input terminal 114 that brings reflected light energy from a sample 130 back into the spectrophotometer 110, a data port 122 that couples to a data cable 134 so that data obtained by the spectrophotometer 110 can be readily transferred to the computer 140. A sampling cable 120 has a proximal end 121 that includes a light source cable 116 coupled to the light output terminal 112 and an input cable 118 coupled to the input terminal 114. The light source cable 116 and the input cable 118 are preferably fiber optic bundles that each include one or more individual fiber optic strands. The light source cable 116 and the input cable 118 preferably merge together as a single cable bundle 126 and extend to a distal end 123 of the sampling cable 120, although it is readily apparent that merging the two bundles is not necessary. The distal end 123 of the sampling cable 120 includes a sampling tip 124 with a sampling element 128. The sampling element 128 is preferably the exposed end of the fiber optic strands. The sampling element 128 both illuminates the sample 130 and sends the reflected light energy back to the spectrophotometer 110. Mated with the input terminal 114 is a fiber optic bundle matching connector 200 constructed in accordance with the present invention. Generally, the fiber optic bundle matching connector 200 provides an adjustable junction between the input cable 118 and the input terminal 114.

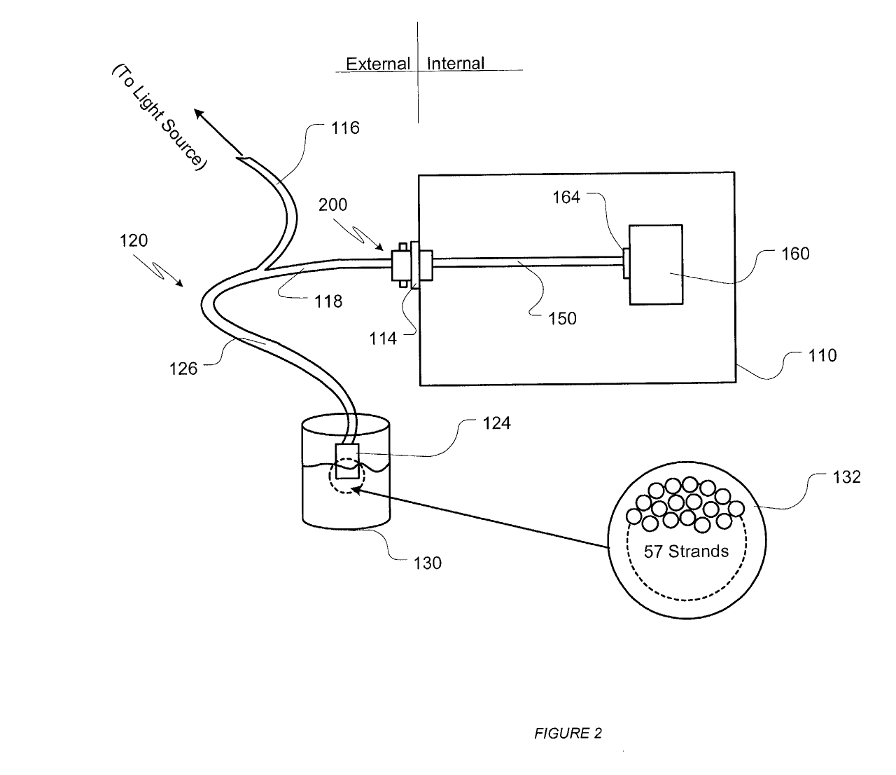

Turning to FIG. 2, portions of the spectrophotometer 1 10 and the spectrophotometer system 100 are shown in greater detail. In a preferred embodiment, the input terminal 114 leads through the wall of the spectrophotometer 110 to an internal fiber optic cable bundle 150. As an example, both the internal fiber optic cable bundle 150 and the input cable 118 include 57 separate fiber optic strands. (See exploded cross section 132). Each of the individual fiber optic strands within the cable bundle 150 is coupled to a spectrum analyzer 160. An adapter 164 mates the fiber optic strands in the cable bundle 150 with the spectrometer 160.

As described in conjunction with FIG. 2, the input cable 118 and the internal fiber optic cable bundle 150 both carry 57 individual fiber optic strands. This format creates a one-to-one relationship between the diameter of the input cable 118 and the internal cable 150, making mating the two cables at the input terminal 114 relatively straightforward, i.e. the input cable 118 fully illuminates the internal bundle 150.

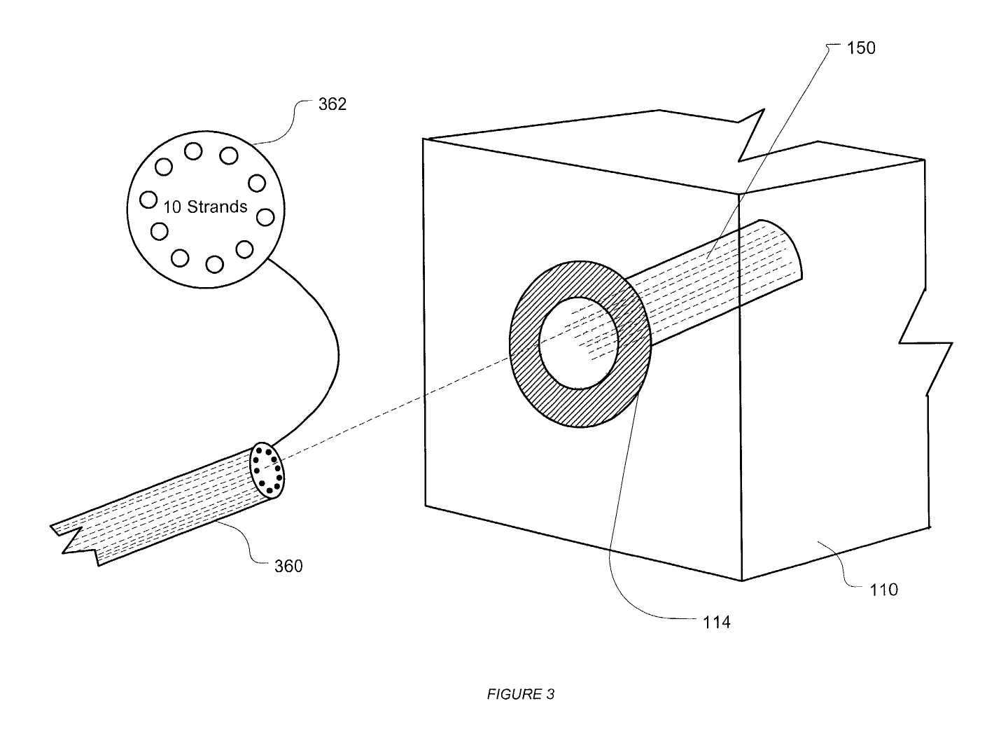

FIG. 3 shows an arrangement where an input cable 360 contains a different number of individual fiber optic strands than its corresponding internal cable bundle 150. In FIG. 3, the input cable 360 has 10 individual fiber optic strands (as shown in the enlarged cross section 362). The input terminal 114 on the spectrophotometer 110 is fixed and couples with the internal cable bundle 150. As described above in conjunction with FIG. 2, the internal cable bundle 150 has a fixed number of fiber optic cables. Since in this example there are just over half as many fiber optic strands in the input cable 360 as in the internal cable bundle 150, the diameters of the input cable 360 and the internal cable bundle 150 are different. In such situations, the internal cable bundle typically cannot be physically joined through a direct connection without sacrificing or compromising the quality of the light energy that is collected at the sample 130.

For example, if the input cable 360 contains fewer individual fiber optic strands than the internal cable bundle 150 and therefore has a smaller diameter, some of the individual fiber optic strands in the internal cable bundle 150 may not receive any light energy from the input cable 360. (See FIG. 3A for illustration). When the input cable 360 is directly abutting the internal cable bundle 150, individual fiber optic strands 151 and 156 may not receive any of the light energy transmitted through the input cable 360. This uneven illumination of the internal fiber optic bundle compromises the quality of the spectrometer measurement.

Similarly, if the input cable 360 contains more individual fiber optic strands than the internal cable bundle 150 and therefore has a larger diameter than the internal cable bundle 150, some of the individual fiber optic strands in the input cable 360 will not align with the cross section of the internal cable bundle 150 and some of the collected light energy will be lost. (See FIG. 3B for illustration). When the input cable 360 is directly connected to the internal cable bundle 150, individual fiber optic cables 361 and 365 may not transmit any of the light energy they carry into the input cable 360. This exclusion of the light from some of the collecting fiber optic strands from that transferred to the internal fiber optic bundle may compromise the quality of the spectrometer measurement.

In either of the situations described in conjunction with FIGS. 3A and 3B, there is a strong likelihood that the results generated by the spectrum analyzer 160 will be incorrect. FIGS. 3A and 3B are meant to be illustrative and do not necessarily represent an accurate scale of the cable bundles in relation to the individual fiber optic strands. In practice, the fiber optic strands are more closely packed within the cable and the non light transmitting protective jacket around the individual strands are usually no more than 10-15% of the diameter of the actual strand.

In order to ensure accurate and reproducible results when using input cables and internal cable bundles with different diameters and/or a different number of individual fiber optic strands, the fiber optic cable matching connector 200 constructed in accordance with the present invention is utilized.

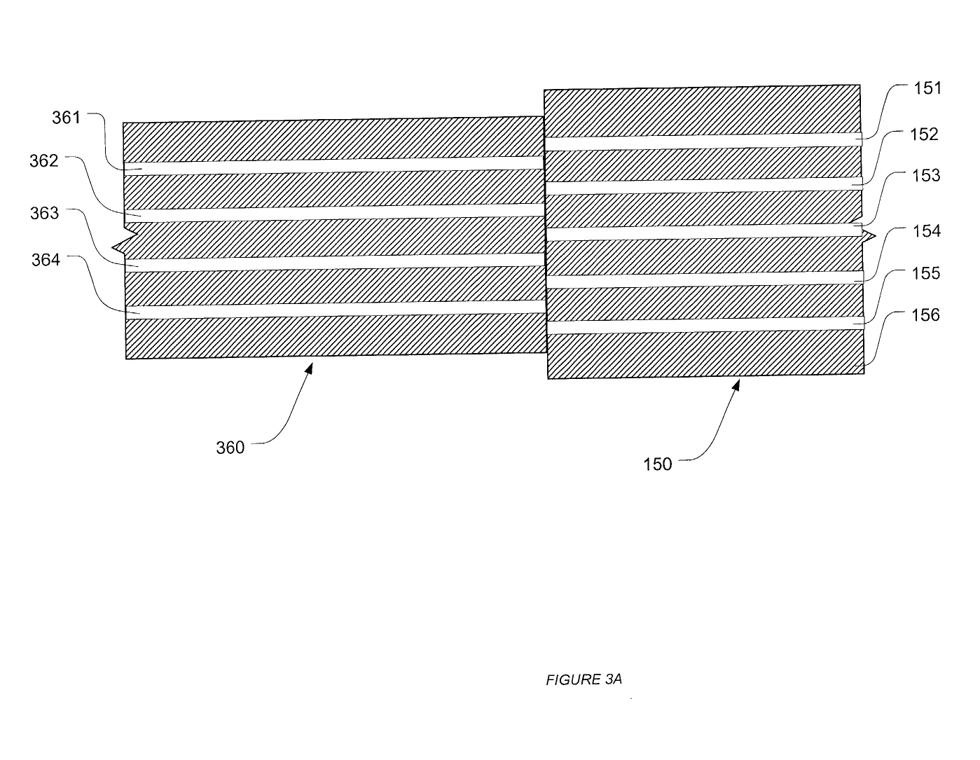

FIGS. 4A and 4B illustrate how the fiber optic cable matching connector 200 provides a non-contact coupling between the two fiber optic cable bundles and ensures that the fiber optic strands in the input cable bundle provide equal and even illumination to the internal fiber optic bundle 150 and that the spectrum analyzer's entrance slit is uniformly illuminated regardless of the diameter of each cable bundle and regardless of the number of individual strands in each bundle. In both FIGS. 4A and 4B the light energy from a sample evenly illuminates the spectrum analyzer's entrance slit. Thus, the accuracy of the measured spectrum is ensured.

Referring to FIG. 4A the cable bundles 360 and 150 are separated from each other by a distance d. When the cable bundle 360 is smaller than the internal bundle 150, the two bundles are positioned such that the diverging beam exiting the external bundle 360 illuminates the full diameter of the exposed end of the internal bundle 150. The angular spread of light leaving a fiber optic cable is defined by the fiber's numerical aperture (NA). In the case of many of the fibers commonly used in the spectrometer industry, the fiber has a NA of 0.22. This translates to a beam angle of about 25°. In this example the fibers have a numerical aperture (NA) of 0.22 and thus the light exits the external bundle 360 in an approximately 25° cone. The exiting light enters the internal bundle 150 any time it falls within this 25° cone. Since all of this light falls within the 25° field-of-view of the internal bundle 150, a maximum amount of the light is transferred from the bundle 360 to the internal bundle 150 and the individual fibers comprising the internal bundle 150 receive an equal amount of illumination.

Referring to FIG. 4B the cable bundles 360 and 150 are now separated from each other by a distance d′. When the external bundle 360 is larger than the internal bundle 150, the two bundles are positioned such that the field-of-view (or collection aperture) of the internal bundle 150 views the entire face of the external fiber optic bundle 360. Even though some of the light delivered by the input cable 360 is lost (i.e. it falls outside the field of view of the internal bundle 150), this spacing ensures that each strand of the input cable 360 contributes illumination to the internal fiber optic bundle 150. The optical efficiency of the connection may be improved by increasing the reflectance of the internal surfaces of the matching connector (e.g. a selection of high reflectance materials and/or polishing such as electro-polishing or nickel plating).

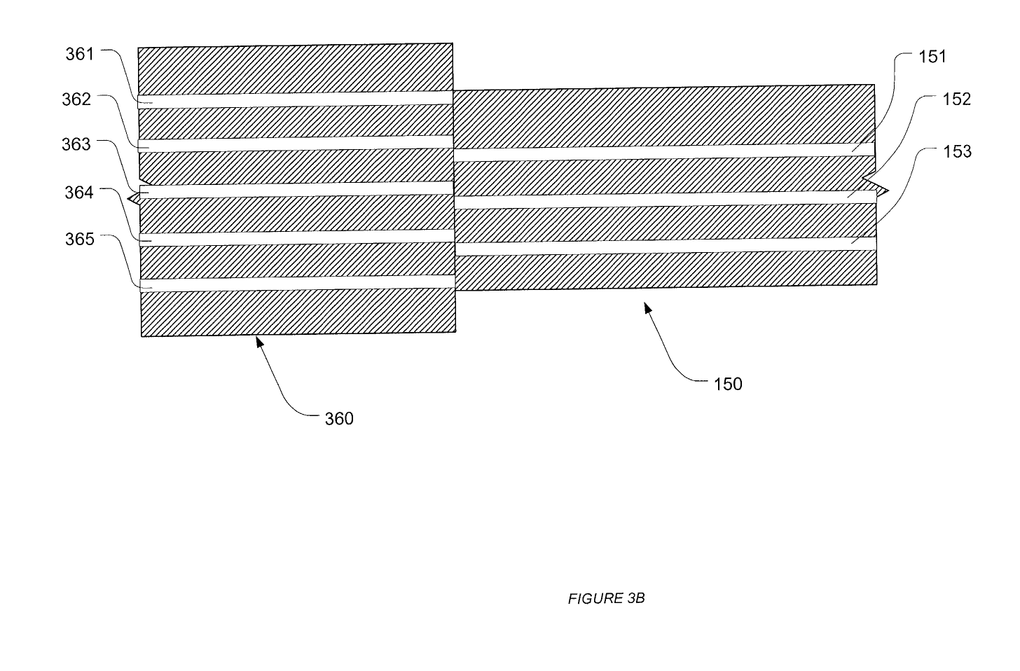

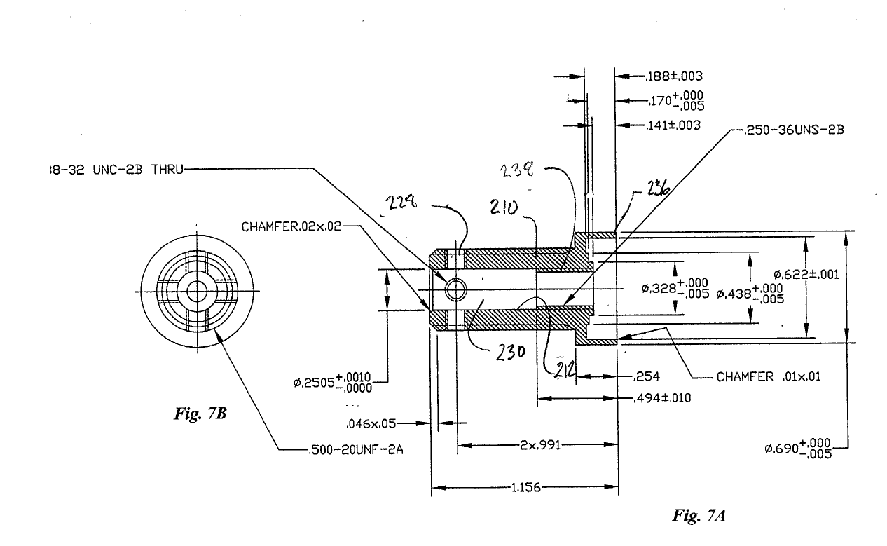

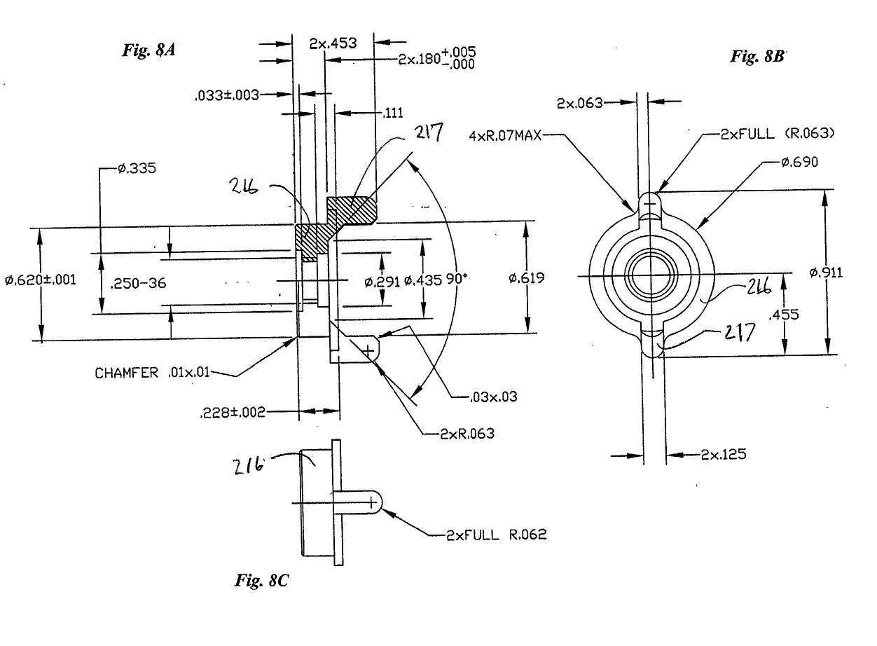

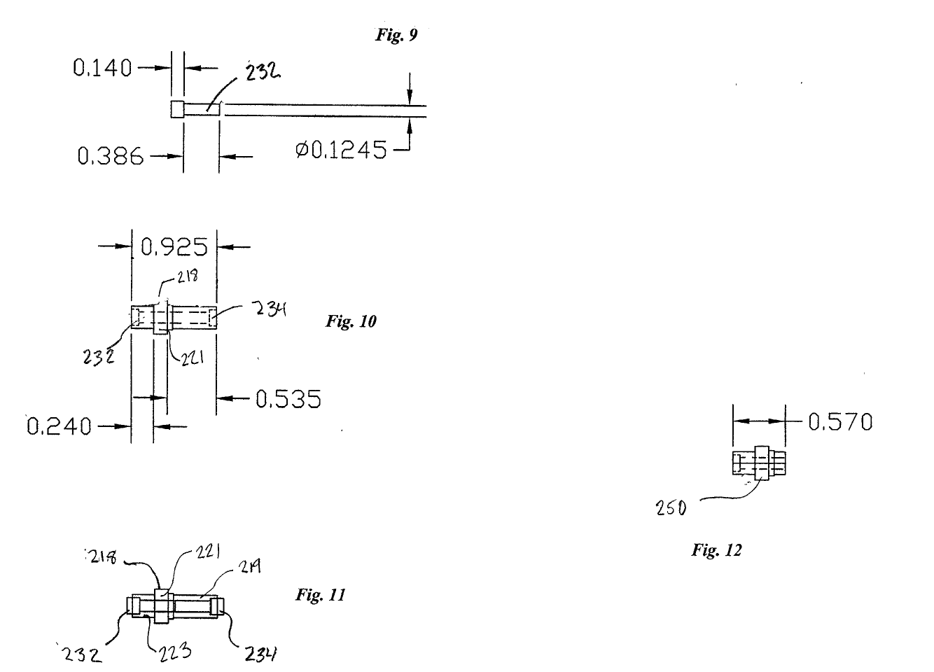

FIGS. 5-12 show the fiber optic bundle matching connector 200 and its various components in further detail. Turning first to FIG. 5, an exploded perspective view showing the main components of the fiber optic bundle matching connector 200 is presented. The fiber optic bundle matching connector 200 includes a housing 210, a spring washer 211, a jam nut 216, and a cable connector 218. The housing 210 has a threaded external surface 213 and includes an aperture 228 adapted to receive a set screw. The threaded external surface 213 of the housing 210 allows the housing to securely engage through the wall of the spectrophotometer 110 or through another solid surface. The housing 210 is generally tubular in shape. Extending along the longitudinal axis of the housing 210 is a passage 212. The passage 212 is also threaded for receipt of the cable connector 218. The jam nut 216 has a threaded aperture 215 along its longitudinal axis that is adapted to engage the cable connector 218. The cable connector 218 has a threaded distal end 219, a threaded proximal end 223 and a hex nut 221. As used herein, the term distal refers to the portions of a component that are further away from the spectrophotometer 110 and the term proximal refers to those portions of a component that are closer to the spectrophotometer 110. The threaded distal end 219 is adapted to engage both the j am nut 216 and the housing 210 through each of their respective apertures. The jam nut 216 further includes opposing extensions 217 that allow a user to easily tighten the jam nut 216 around the cable connector 218 and into the housing 210. Tightening the jam nut 216 secures the cable connector 218 in place. Preferably the threaded ends 219 and 223 of the cable connector 218 are SMA type fittings designed to engage with a standard SMA connector. For example, as shown in FIG. 5, the input cable 118 includes an SMA connector 220 that engages with the threaded proximal end 223 of the cable connector 218.

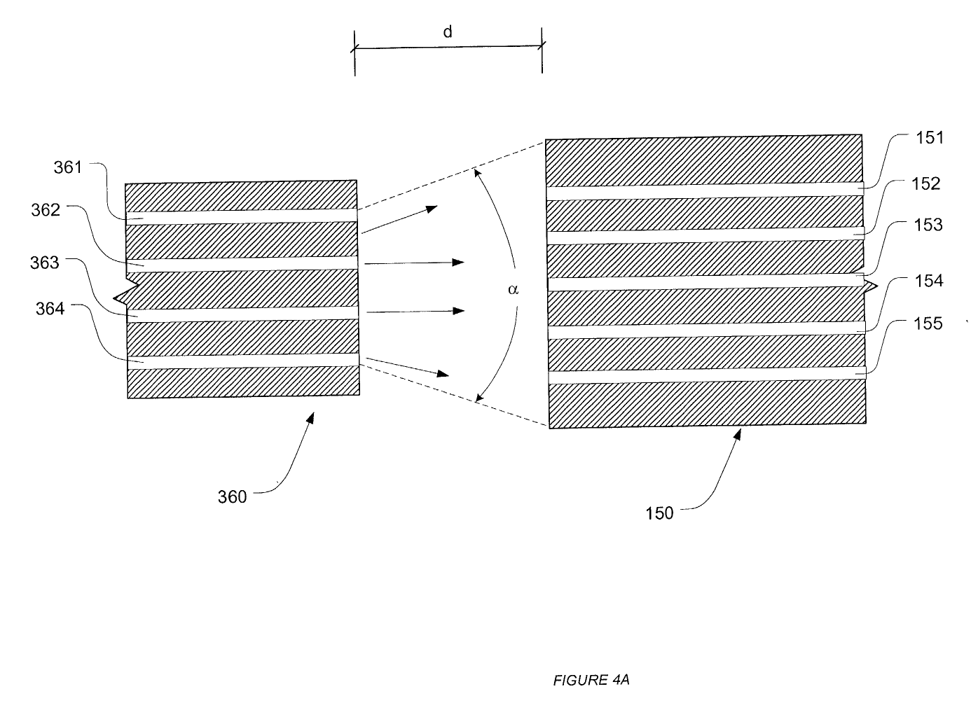

In FIGS. 6A and 6B, the fiber optic bundle matching connector 200 is shown engaged through the wall of the spectrophotometer 110. The fiber optic bundle matching connector 200 engages the input cable 118 at a proximal end 204 and engages the internal cable bundle 150 at a distal end 202. The input cable 118 includes an SMA connector 220 that threads onto the threaded proximal end 223 of the cable connector 218. An aperture 114 through the wall of the spectrophotometer 110 provides a mounting location for the fiber optic bundle matching connector 200. An internal casing wall 214 of the spectrometer 110 also includes an aperture 114a for the fiber optic bundle matching connector 200 to pass through. A lockwasher 224, and a nut 226 secure the fiber optic cable matching connector 200 in the aperture 114 of the spectrophotometer 110. The housing internal chamber 212 receives the threaded end 219 of the cable connector 218.

As mentioned previously, the SMA connector 220 is preferably a fiber optic fitting that receives the input cable 118 and feeds collected light energy from the sample 130, through a passage in the cable connector 218 to the spectrophotometer 110. The individual strands of optical fiber are loosely threaded through the fiber optic cable's housing. At the ends of the cable, the fibers pass into the terminating connectors (e.g. a SMA connector) and are fixed in place. When the connector is viewed from the end of a fiber optic cable assembly the ends of the individual strands of optical fiber arrayed in a circular bundle are visible.

Other types of connectors, both standard and proprietary, may also be utilized. In most cases, the connectors provide a means to hold the polished ends of the optic fiber strands in a fixed geometry relative to the mating connector.

The cable connector 218 preferably comprises a tubular housing that can transmit fiber optic energy from one end to the other. The cable connector 218 also includes a hex nut 221 that allows the cable connector 218 to be rotated, either manually or with a bolt driver, and thereby longitudinally positioned within the housing 210. By positioning the cable connector 218 within the housing 210, the distance between two opposing fiber optic cable tips retained within the fiber optic bundle matching connector 200 can be adjusted. Markings on the surface of the hex nut 221 allow the distance between the exposed end of the input cable 118 and exposed end of the internal cable 150 to be determined with more precision.

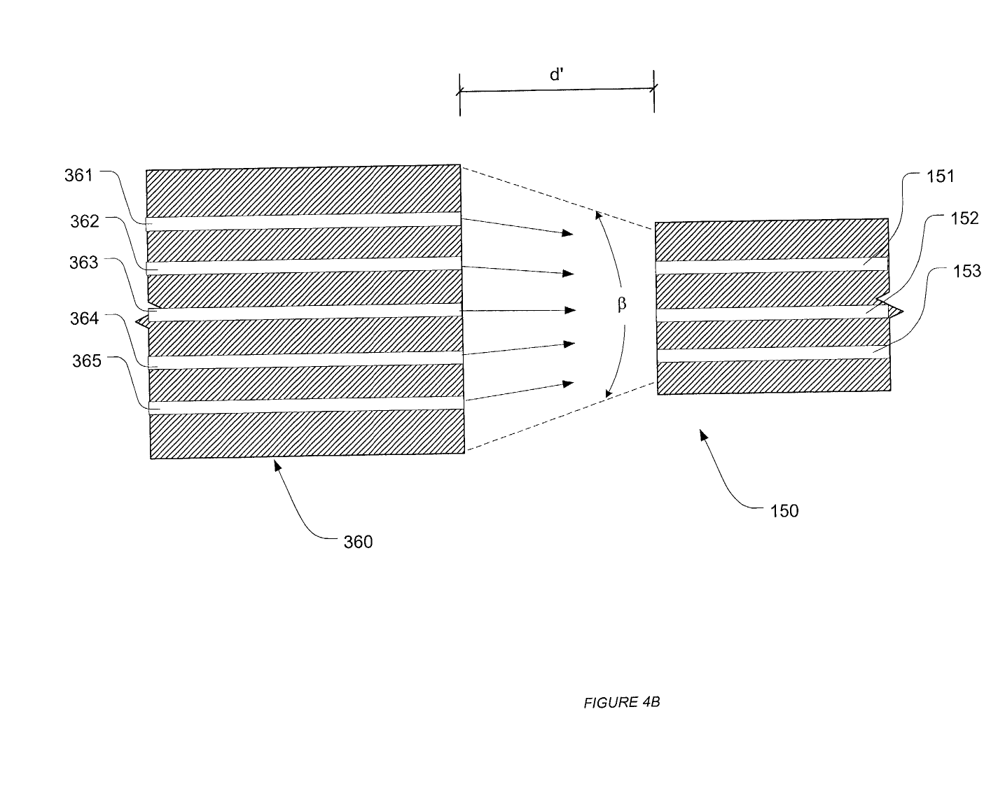

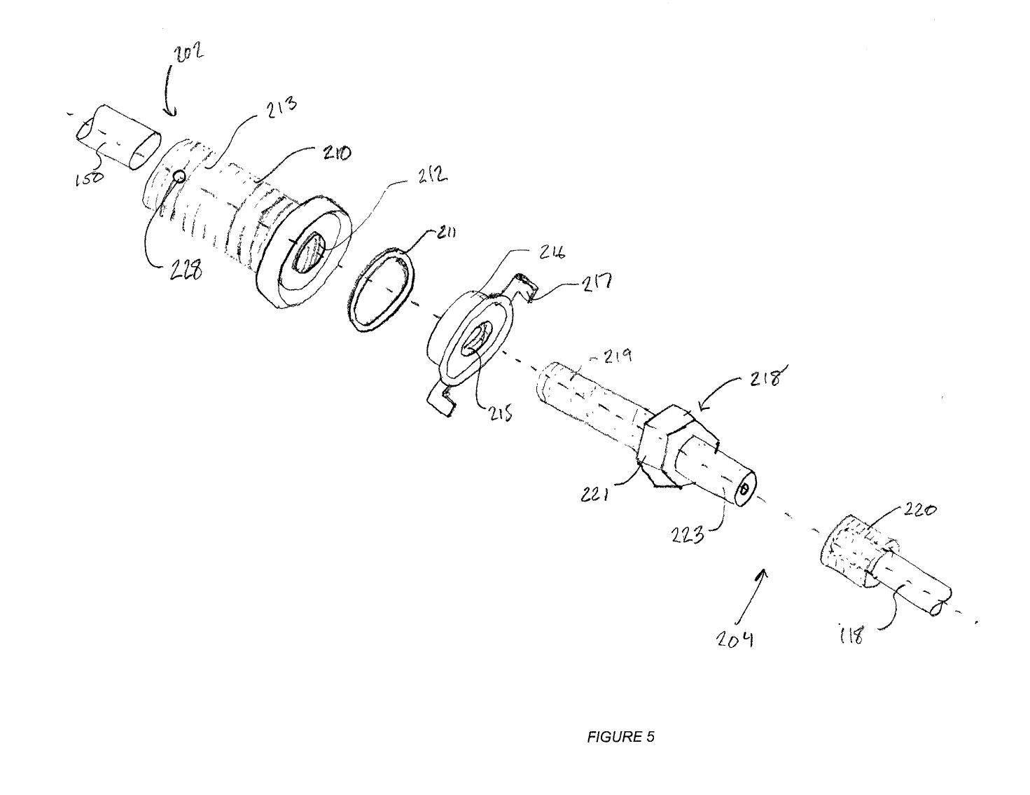

FIGS. 7A and 7B show the housing 210 in greater detail. The housing 210 has an inner bushing 238 that carries the threads that engage the cable connector 218. Variously sized bushings 238 can be inserted into the chamber 212 in order to accommodate differently sized cable connectors. The fiber optic bundle matching connector 200 can therefore be easily adapted for use with many different makes and models of spectrophotometers having variously sized internal fiber optic cable bundles 150. The housing 210 also includes a flanged end 236 that is shaped to receive the jam nut 216 and externally engage with the aperture 114 through the wall of the spectrophotometer 110. FIGS. 8A and 8B show a preferred embodiment of the jam nut 216.

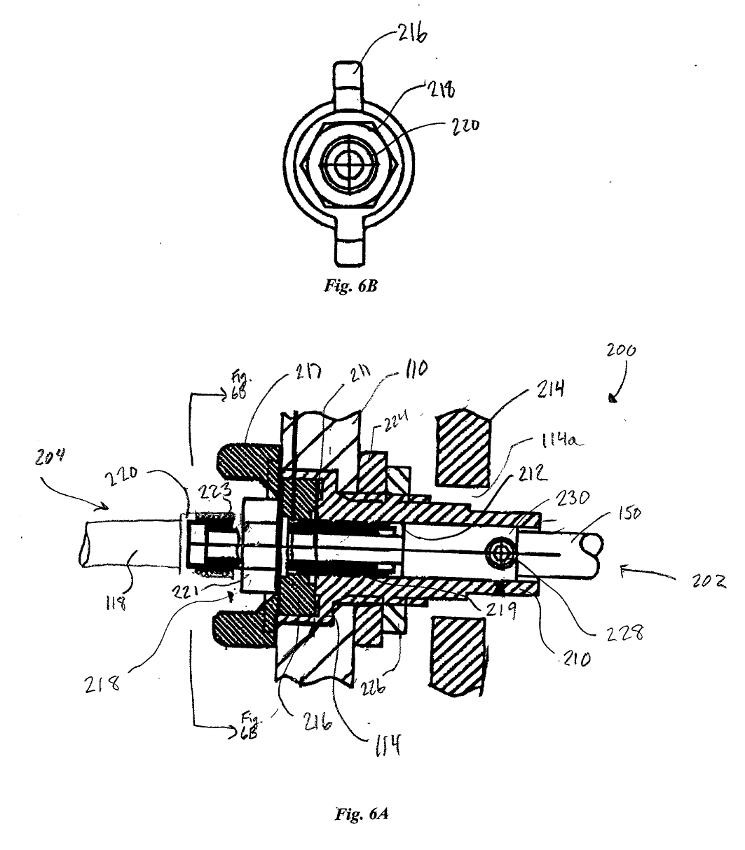

Turning to FIGS. 9-12 the cable connector 218 receives an input tip 232 and an output tip 234. The input tip 232 is coupled to the input cable 118 and the output tip 234 is coupled to the fiber optic cable bundle 150. The input tip 232 and the output tip 234 provide a uniform connection between the respective fiber optic cable bundles and the cable connector 218. When both the input tip 232 and the output tip 234 are fully inserted into the cable connector 218, they are in contact with each other. The housing aperture 228 receives a set screw that when tightened through the aperture 228, secures the output tip 234 and cable bundle 150 in place within the housing 210 and cable connector 218.

When the cable connector 218 is rotated clockwise via the hex nut 221, the input tip 232 will move toward the output tip 234 (i.e. to the right in FIG. 6A). Conversely, when the cable connector 218 is rotated counter-clockwise via the hex nut 221, the input tip 232 will move away from the output tip 234 (i.e. to the left in FIG. 6A). The jam nut 216 is preferably a compression-type fitting and when tightened will secure the cable connector 218 in position. The spring washer 211 ensures a secure fit between the jam nut 216 and the housing 210 and also minimizes movement of the cable connector 218.

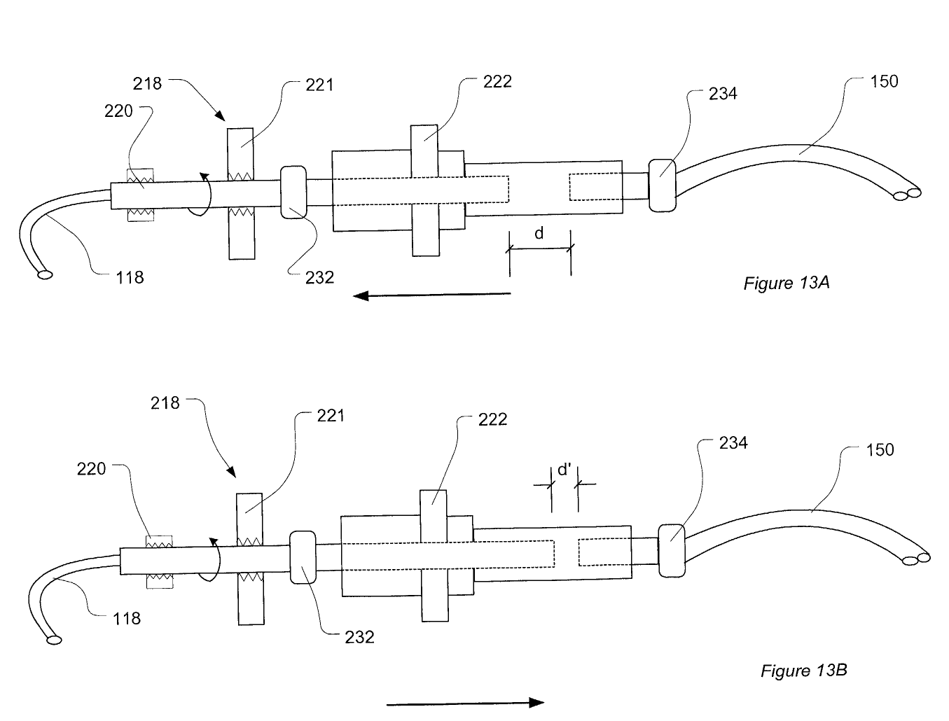

FIGS. 13A and 13B illustrate how the distance between the input tip 232 and the output tip 234 varies when the hex nut 218 is turned counter-clockwise (FIG. 13A), and clockwise (FIG. 13B), as well as the varying spacing (d and d′) that can be achieved by utilizing a fiber optic cable matching connector constructed in accordance with the present invention.

It is noted that the dimensional information contained in FIGS. 7-12 are associated with a preferred design of the fiber optic bundle matching connector 200. However, these dimensions are in no way meant to be limiting and it is contemplated that variously sized fiber optic bundle matching connectors may be constructed to accommodate a wide variety of spectrophotometers applications. Similarly, each of the individual dimensions shown in FIGS. 7-12 may be altered in order to accommodate any number of specialized situations.

Although the present invention has been described and illustrated in the above description and drawings, it is understood that this description is by example only and that numerous changes and modifications can be made by those skilled in the art without departing from the true spirit and scope of the invention. The invention, therefore, is not to be restricted, except by the following claims and their equivalents.

What is claimed is:

1. A fiber optic cable coupler, comprising:
a housing adapted to receive a first fiber optic cable, the first fiber optic cable having an exposed end;
a cable connector having a distal end and a proximal end, the distal end adapted to engage the housing, the proximal end adapted to receive a second fiber optic cable, the second fiber optic cable having an exposed end;
wherein the cable connector retains the second fiber optic cable so that the second fiber optic cable exposed end is opposed to and in longitudinal alignment with the first fiber optic cable exposed end; and
wherein the cable connector is adapted to maintain a user selectable distance between the first fiber optic cable exposed end and the second fiber optic cable exposed end.

2. The fiber optic cable coupler of claim 1, wherein the housing has an outer surface, a longitudinal axis, and a threaded passage extending along the longitudinal axis.

3. The fiber optic cable coupler of claim 2, wherein the cable connector has a threaded outer surface, and wherein the distal end of the cable connector screws into the housing passage.

4. The fiber optic cable coupler of claim 1, wherein the cable connector is substantially tubular and has a threaded outer surface and an internal surface.

5. The fiber optic cable coupler of claim 4, wherein the cable connector internal surface has a reflective finish adapted to transmit light energy.

6. The fiber optic cable coupler of claim 5, wherein the cable connector internal surface is electropolished.

7. The fiber optic cable coupler of claim 5, wherein the cable connector is formed from nickel plated brass.

8. The fiber optic cable coupler of claim 1, wherein the housing is substantially tubular and has a threaded outer surface.

9. The fiber optic cable coupler of claim 1, wherein rotating the cable connector in a first direction decreases the user selectable distance between the first fiber optic cable exposed end and the second fiber optic cable exposed end; and
wherein rotating the cable connector in a second direction decreases the user selectable distance between the first fiber optic cable exposed end and the second fiber optic cable exposed end.

10. The fiber optic cable coupler of claim 9, wherein a single rotation of the cable connector alters the distance between the first fiber optic cable exposed end and the second fiber optic cable exposed end between 0.02 and 0.06 inches.

11. The fiber optic cable coupler of claim 1, further comprising:
a jam nut adapted to engage with the cable connector distal end and the housing; and
a spring washer positioned intermediate the jam nut and the housing.

12. The fiber optic cable coupler of claim 11, wherein the jam nut has a threaded opening that engages the cable connector distal end; and
wherein rotating the jam nut in a first direction restrains the movement of the cable connector.

13. The fiber optic cable coupler of claim 11, wherein the jam nut has an outer surface and further comprises a flange extending from the outer surface.

14. The fiber optic cable coupler of claim 2, wherein the housing further comprises an aperture extending from the outer surface into the passage.

15. The fiber optic cable coupler of claim 1, wherein the cable connector proximal end is further adapted to engage a SMA connector.

16. The fiber optic cable coupler of claim 1, further comprising an extension protruding from the cable connector.

17. The fiber optic cable coupler of claim 16, wherein the extension is a hex nut formed into the cable connector.

18. The fiber optic cable coupler of claim 1, wherein the first and second fiber optic cables comprise a plurality of fiber optic strands.

19. The fiber optic cable coupler of claim 8, wherein the housing is adapted to mount to a surface.

20. A device for transmitting light energy from an exposed end of a first fiber optic cable bundle to an exposed end of a second fiber optic cable bundle, comprising:
a first housing adapted to retain the first fiber optic cable bundle, the first housing having a longitudinal axis and a passage extending along the longitudinal axis;
a second housing adapted to engage the first housing and retain the second fiber optic cable bundle, the second housing adapted to maintain a user selected distance between the first and second fiber optic cable bundle exposed ends.

21. The device of claim 20, wherein the second housing comprises a tubular member, the tubular member comprising:
a threaded outer surface;
a proximal end;
a distal end; and
an inner surface conducive to transmitting light energy from the proximal end to the distal end.

22. The device of claim 21, wherein the first housing comprises:
a tubular member with a threaded outer surface and a threaded inner surface;
wherein the second housing threaded outer surface is adapted to engage the first housing threaded inner surface.

23. The device of claim 20, further comprising a retention device engaged with the first housing and the second housing.

24. The device of claim 22, wherein rotation of the second housing alters the distance between the first and second fiber optic cable bundle exposed ends.

25. The device of claim 20, further comprising an analyzer coupled to the first fiber optic cable bundle.

26. The device of claim 20, further comprising a cable splitter, the cable splitter adapted to divide the first fiber optic cable bundle into at least two smaller fiber optic cable bundles and wherein each of the smaller fiber optic cable bundles is coupled to an analyzer.

27. The device of claim 20, wherein the first fiber optic cable bundle has a first diameter and the second fiber optic cable bundle has a second diameter.

28. A fiber optic cable coupler, comprising:
means for retaining a first fiber optic cable bundle;
means for retaining a second fiber optic cable bundle;
means for longitudinally aligning the first and second fiber optic cable bundles; and
means for adjusting the distance between the first and second fiber optic cables.

29. The fiber optic cable coupler of claim 28, further comprising means for transmitting light energy from the first fiber optic cable bundle to the second fiber optic cable bundle.

30. The fiber optic cable coupler of claim 28, wherein the means for adjusting the distance between the first and second fiber optic cables is a threaded connection.

31. The fiber optic cable coupler of claim 28, wherein the means for longitudinally aligning the first and second fiber optic cable bundles is an SMA-SMA connector comprising a tubular member with a polished internal surface.

32. A method of coupling fiber optic cables having different diameters, comprising:
retaining a first fiber optic cable in a first position, the first fiber optic cable having an exposed end;
retaining a second fiber optic cable in a second position, the second fiber optic cable having an exposed end,
longitudinally aligning the first and second fiber optic cable exposed ends; and
adjusting the distance between the first and second fiber optic cable exposed ends so that light energy emitted by the first fiber optic cable exposed end evenly illuminates the second fiber optic cable exposed end.

33. The method of claim 32, wherein the first fiber optic cable has a diameter that is smaller than the second fiber optic cable.

34. The method of claim 32, wherein the second fiber optic cable has a diameter that is smaller than the first fiber optic cable.

35. The method of claim 32, further comprising providing a reflective passage between the first and second fiber optic cable exposed ends.

36. A spectrophotometer system, comprising:
a spectrum analyzer;
a first fiber optic cable bundle having a proximal end and a distal end, the distal end coupled to the spectrum analyzer, the proximal end coupled to a fiber optic cable matching connector; and
a fiber optic sampling cable having a proximal end and a distal end, the distal end coupled to the fiber optic cable matching connector, the proximal end coupled to a sampling tip;
wherein the fiber optic cable matching connector comprises
a first housing adapted to retain the proximal end of the first fiber optic cable bundle, the first housing having a longitudinal axis and a passage extending along the longitudinal axis; and
a second housing adapted to engage the distal end of the fiber optic sampling cable, the second housing adapted to maintain a user selected distance between the first and second fiber optic cable bundle exposed ends.

37. A method for optically coupling a first fiber optic element having a first optical aperture to a second fiber optic element having a second optical aperture, the method comprising:
aligning a light emitting end of the first fiber optic element with a light receiving end of the second fiber optic element, and
fixedly positioning the light emitting end of the first fiber optic element and the light receiving end of the second fiber optic element a predetermined distance apart such that light emitted by the first fiber optic element may illuminate substantially all of the light receiving end of the second fiber optic element.

38. The method of claim 37 wherein the entire optical surface of the light receiving end of the second fiber optic element may view the entire optical surface of the light emitting end of the first fiber optic element.

39. The method of claim 37, wherein the first fiber optic element and second fiber optic element comprise fiber optic bundles having differing numbers of internal fiber optic strands.
